(19) United States
(12) Patent Application Publication
(10) Pub. No.: US 2006/0228284 A1
(43) Pub. Date: Oct. 12, 2006

(54) Integration of gasification and ammonia production

(76) Inventor: Craig Alan Schmidt, Kingsport, TN (US)

Correspondence Address: ERIC D. MIDDLEMAS;EASTMAN CHEMICAL COMPANY, P. O. BOX 511, KINGSPORT, TN, 37662-5075, US

(21) Appl. No.: 11/191,889

(22) Filed: Jul. 28, 2005

Related U.S. Application Data
(60) Provisional application No. 60/670,065, filed on Apr. 11, 2005.

(51) Int. Cl. C01C 1/00; C01B 3/02

(52) U.S. Cl. 423/352; 423/648.1

(57) ABSTRACT

A method and system are described for making ammonia using hydrogen from a gasification process and for integrating the steam systems of the two processes. The gasification process provides high-pressure, purified hydrogen and high-pressure, saturated steam. The high pressure hydrogen lowers the overall compression requirement for the ammonia process. In addition, the high-pressure, saturated steam can be converted into superheated steam by recovering heat from ammonia synthesis and used to power steam turbines for compression and refrigeration needs.

### CROSS REFERENCES TO RELATED APPLICATIONS

This application claims the benefit of U.S. Provisional Application Ser. No. 60/670,065 filed Apr. 11, 2005.

### FIELD OF THE INVENTION

This invention generally relates to the synthesis of ammonia. More particularly, this invention relates to a novel process for producing ammonia by using a gasification process to produce hydrogen and integrating the steam systems of the two processes. The invention can provide sufficient steam to power existing steam extraction turbine drivers and thereby reduce the cost of operating an ammonia synthesis process.

### BACKGROUND OF THE INVENTION

The reaction of nitrogen and hydrogen to provide ammonia is well known. The commercial production of ammonia was developed in the early 1900s. Ammonia is produced by the direct reaction of hydrogen gas and nitrogen gas over an iron-based catalytic surface:
3H₂→N₂→2NH₃
The ammonia synthesis reaction is exothermic; hence, the equilibrium will be shifted to the right as the reaction temperature is lowered. As a practical matter, however, the reaction temperature must be maintained at a sufficiently elevated level to permit the synthesis of acceptable quantities of product in a reasonably short time. This is true even though a catalyst is customarily employed to accelerate the reaction rate. Thermodynamic considerations also favor carrying out the reaction at high pressures, typically in the range of about 15 to about 346 bar. These high pressures require considerable energy, usually in the form of steam or electricity, for compression.

Generally, the commercial synthesis of ammonia has three main steps. First, the ammonia synthesis feedstock gas is prepared. This involves generating hydrogen gas, removing impurities and catalysts poisons from the hydrogen gas, and combining nitrogen with the hydrogen gas in stoichiometric proportions. Catalyst poisons are mainly carbon dioxide and carbon monoxide, although sulfur may also poison the catalyst. Historically, carbon monoxide in the gas is converted to hydrogen and carbon dioxide using the water-gas shift reaction, which involves the reaction with steam over a catalyst. Carbon dioxide can be removed by various gas purification technologies. Nitrogen gas is typically fed to the suction side of the ammonia synthesis loop compressor. Second, the ammonia synthesis feedstock gas is passed through the ammonia synthesis reactor. Third, the ammonia product gas leaving the ammonia synthesis reactor is cooled, the ammonia product is recovered, and unreacted ammonia synthesis gas is recycled.

Steam methane reforming (SMR) has been the traditional source of hydrogen for ammonia synthesis. The natural gas-based ammonia industry uses natural gas both as a feedstock and as an energy (fuel) supply. Rising natural gas prices, however, have caused several ammonia producers to either permanently close or investigate alternative ways to economically generate hydrogen.

Gasification is becoming an attractive method to generate the quantity of hydrogen required for world-class ammonia production facilities. Gasification can provide a stable and reliable feedstock that is not subject to rapid market fluctuations. Gasification can be used to generate synthesis gas or “syngas” from hydrocarbon feedstocks such as coal, petroleum coke, residual oil, and other materials for years. The hydrocarbon feedstock is gasified in the presence of oxygen. Oxygen is usually generated by an air separation plant in which nitrogen is removed from the air to form purified oxygen.

The availability of nitrogen from air separation and hydrogen-containing syngas from gasification has led to the use of gasification as a means to supply hydrogen and nitrogen feedstock for ammonia synthesis. Syngas produced in the gasifier can be passed to a shift reaction section where CO is converted to H₂ and CO₂ by reaction with steam over a catalyst. The shifted gas may be refined further, often by separation to form a purified hydrogen gas stream. For example, the shifted syngas stream can be purified in an acid gas removal and purification section, and the purified hydrogen product can be supplied to the ammonia synthesis reaction loop. The synthesis gas stream can be processed to obtain a hydrogen gas stream of greater than 99.9 mole percent purity. By-product nitrogen gas may be taken from the oxygen plant, purified, and then mixed with the hydrogen gas to create the ammonia synthesis feedstock gas.

The integration of gasification with new and existing natural gas-based ammonia processes, in general, has not been energy efficient and cost effective. In particular, past designs have not generated sufficient steam and has resulted in the need to replace steam extraction turbine drivers with electric motors. The use of electric motors, however, increases the initial capital cost of the integration project and results in higher operating and maintenance costs. Thus, it would be desirable to solve the problem of integrating gasification into new and existing natural gas-based ammonia plants such that there is sufficient power, in the form of steam, to drive process equipment without the need for electric motors.

### SUMMARY OF THE INVENTION

Processes for the production of ammonia may be efficiently integrated with gasification processes as a source of high pressure hydrogen and steam. Thus, in a first aspect, the invention relates to a method for integrating a process for making hydrogen with a process for making ammonia. The method comprises:
(a) reacting a carbonaceous material with oxygen in a gasification process, the gasification process comprising a high-pressure gasifier and a CO shift reaction section having a shift reaction section product stream;
(b) passing a high-pressure synthesis gas stream comprising hydrogen from the gasification process as a feed to a process for making ammonia, the ammonia-making process comprising an ammonia converter section having an ammonia product stream;
(c) generating high-pressure, saturated steam using heat from the shift reaction section product stream;
(d) heat exchanging all or a portion of the high-pressure, saturated steam from step (c) with all or a portion of the ammonia product stream to produce superheated steam, wherein at least 50% of the total superheated steam load for the ammonia process is produced by the heat-exchange; and
(e) passing the superheated steam to a steam turbine driver for a hydrogen and nitrogen feedstock compressor, a steam turbine driver for an ammonia refrigeration compressor, or to both.
   The gasification process produces a high pressure gas stream comprising hydrogen which requires less compression energy than a traditional hydrogen feedstock from natural gas reforming. In addition, the gasification process provides high pressure saturated steam which can be integrated efficiently with the heat production of an ammonia synthesis plant to produce super-heated steam that can be used to drive steam turbines for gas compression and other energy needs.

In second aspect, the invention relates to an integrated process for making hydrogen and ammonia. The method comprises:
(a) reacting a carbonaceous material with oxygen in a high-pressure gasifier to produce a high-pressure gasifier product stream comprising hydrogen, carbon dioxide, carbon monoxide, and water;
(b) passing the gasifier product stream to a CO shift reaction section to produce a high-pressure shift reaction section product stream comprising additional hydrogen and carbon dioxide;
(c) generating high-pressure, saturated steam using heat from the shift reaction section product stream;
(d) passing the shift reaction section product stream to a purification section to remove CO₂ and H₂S, and form a high-pressure, purified gasification product stream comprising hydrogen;
(e) passing the high-pressure, purified gasification product stream and nitrogen to a hydrogen and nitrogen feedstock compressor to produce an ammonia converter feedstream;
(f) passing the ammonia converter feedstream to an ammonia converter section to form an ammonia product stream;
(g) heat exchanging the ammonia product stream with the high-pressure, saturated steam from the shift reaction section to form superheated steam, wherein at least 50% of the total superheated steam load for the ammonia process is produced by the heat-exchange; and
(h) passing the superheated steam to a steam turbine driver for the hydrogen and nitrogen feedstock compressor, a steam turbine driver for an ammonia refrigeration compressor, or to both.

In a third aspect, the invention relates to an integrated system for making hydrogen and ammonia. The system comprises:
(a) a high-pressure gasifier for reacting a carbonaceous material with oxygen to produce a high pressure gasifier product stream comprising hydrogen, carbon dioxide, carbon monoxide, and water;
(b) a CO shift reaction section for converting the carbon monoxide and water in the gasifier product stream to produce a high-pressure shift reaction section product stream comprising additional hydrogen and carbon dioxide;
(c) a first heat exchanger section for generating high-pressure, saturated steam using heat from the shift reaction section product stream;
(d) a purification section for removing CO₂ and H₂S, and forming a high-pressure, purified gasification product stream comprising hydrogen;
(e) a nitrogen and hydrogen feedstock compressor for compressing the high-pressure, purified gasification product stream and nitrogen to produce an ammonia converter feedstream;
(f) an ammonia converter section for reacting hydrogen with nitrogen in the ammonia converter feedstream to produce a product stream comprising ammonia;
(g) a second heat exchanger section for exchanging heat from the ammonia product stream to the high-pressure, saturated steam from the shift reaction section to form superheated steam; and
(h) a steam turbine driver for the nitrogen and hydrogen feedstock compressor or a steam turbine driver for an ammonia refrigeration compressor, which receives at least a portion of the superheated steam.

### BRIEF DESCRIPTION OF THE DRAWINGS

FIG. 1 is a block flow diagram showing integration of a gasifier into an existing ammonia plant according to the invention.

FIG. 2 is a simplified process flow diagram of an ammonia synthesis plant and integrated steam system according to the invention.

### DETAILED DESCRIPTION OF THE INVENTION

The gasification of carbonaceous materials can be used to produce high pressure hydrogen and steam for use in the production of ammonia. Integration of a gasification and ammonia process can be accomplished in a cost effective and energy efficient manner and provides an economically attractive alternative to hydrogen from natural gas reforming. Thus, in a general embodiment, the present invention provides a method for integrating a process for making hydrogen with a process for making ammonia, comprising:
(a) reacting a carbonaceous material with oxygen in a gasification process, the gasification process comprising a high-pressure gasifier and a CO shift reaction section having a shift reaction section product stream;
(b) passing a high-pressure synthesis gas stream comprising hydrogen from the gasification process as a feed to a process for making ammonia, the ammonia-making process comprising an ammonia converter section having an ammonia product stream;
(c) generating high-pressure, saturated steam using heat from the shift reaction section product stream;
(d) heat exchanging all or a portion of the high-pressure, saturated steam from step (c) with all or a portion of the ammonia product stream to produce superheated steam, wherein at least 50% of the total superheated steam load for the ammonia process is produced by the heat-exchange; and
(e) passing the superheated steam to a steam turbine driver for a hydrogen and nitrogen feedstock compressor, a steam turbine driver for an ammonia refrigeration compressor, or to both.
   The gasifier produces a gas stream comprising carbon monoxide, carbon dioxide, and hydrogen, which can be converted to additional hydrogen and carbon dioxide using a water-gas shift reaction. The hydrogen thus produced is available at higher pressures than from traditional natural gas reforming processes and thus requires less compression when used as a feedstock for ammonia synthesis. In addition, the water-gas shift reaction provides high pressure, saturated steam which can be upgraded with the heat produced in an ammonia synthesis plant to produce superheated steam that can be used to drive steam turbines for gas compression and other energy needs.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.113, etc., and the endpoints 0 and 0. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used in the specification and the appended claims, the singular forms “a,” “an” and “the” include their plural referents unless the context clearly dictates otherwise. For example, reference to a “turbine,” or a “pump,” is intended to include a plurality of turbines or pumps. References to a composition containing or including “an” ingredient or “a” compound is intended to include other ingredients or other compounds, respectively, in addition to the one named.

By “comprising” or “containing” or “including” we mean that at least the named compound, element, particle, or method step, etc., is present in the composition or article or method, but does not exclude the presence of other compounds, catalysts, materials, particles, method steps, etc, even if the other such compounds, material, particles, method steps, etc., have the same function as what is named, unless expressly excluded in the claims.

It is also to be understood that the mention of one or more method steps does not preclude the presence of additional method steps before or after the combined recited steps or intervening method steps between those steps expressly identified. Moreover, the lettering of process steps or ingredients is a convenient means for identifying discrete activities or ingredients and the recited lettering can be arranged in any sequence, unless otherwise indicated. In addition, unless otherwise indicated, all pressure values and ranges refer to absolute pressure.

The invention comprises the gasification of carbonaceous materials to create a mixture of hydrogen, carbon monoxide, and carbon dioxide (also known as synthesis gas or syngas). The term “carbonaceous” as used herein to describe various suitable feedstocks that contain carbon and is intended to include gaseous, liquid, and solid hydrocarbons, hydrocarbonaceous materials, and mixtures thereof. Substantially any combustible carbon-containing organic material, or slurries thereof, may be included within the definition of the term “carbonaceous”. Solid, gaseous, and liquid feeds may be mixed and used simultaneously; and these may include paraffinic, olefinic, acetylenic, naphthenic, and aromatic compounds in any proportion. Also included within the definition of the term “carbonaceous” are oxygenated carbonaceous organic materials including carbohydrates, cellulosic materials, aldehydes, organic acids, alcohols, ketones, oxygenated fuel oil, waste liquids and by-products from chemical processes containing oxygenated carbonaceous organic materials, and mixtures thereof. Coal, petroleum-based feedstocks including petroleum coke and other carbonaceous materials, waste hydrocarbons, residual oils, and byproducts from heavy crude oil are commonly used for gasification reactions.

The present invention uses a high-pressure gasifier to produce syngas. Any one of several known gasification processes can be incorporated into the process of the instant invention. In the high-pressure gasification reactor, the carbonaceous fuel is reacted with a oxygen containing gas, optionally in the presence of a temperature moderator, such as steam, to produce synthesis gas. These gasification processes generally fall into broad categories such as, for example, as laid out in Chapter 5 of “Gasification”, (C. Higman and M. van der Burgt, Elsevier, 2003). Examples are moving bed gasifiers such as the Lurgi dry ash process, the British Gas/Lurgi slagging gasifier, the Ruhr 100 gasifier; fluid-bed gasifiers such as the Winkler and high temperature Winkler processes, the Kellogg Brown and Root (KBR) transport gasifier, the Lurgi circulating fluid bed gasifier, the U-Gas agglomerating fluid bed process, and the Kellogg Rust Westinghouse agglomerating fluid bed process; and entrained-flow gasifiers such as the Texaco, Shell, Prenflo, Noell, E-Gas (or Destec), CCP, Eagle, Koppers-Totzek processes. The gasifiers contemplated for use in the process may be operated over a range of pressures and temperatures between about 1 to 104 bar absolute (referred to hereinafter as “bar”) and 400° C. to 2000° C. Typically, the high-pressure gasifier has a pressure operating range of 22 to 84 bar. Other examples of operating pressures are 42 to 84 bar and from 67 to 77 bar. Temperatures within the gasification a typically are the range of about 900° C. to 1700° C., and more typically in the range of about 1100° C. to about 1500° C.

Depending on the carbonaceous feedstock used therein and type of gasifier utilized to generate the gaseous carbon monoxide, carbon dioxide, and hydrogen, preparation of the feedstock may comprise grinding, and one or more unit operations of drying, slurrying the ground feedstock in a suitable fluid (e.g., water, organic liquids, supercritical or liquid carbon dioxide). The carbonaceous fuels are reacted with a reactive oxygen-containing gas, such as air, substantially pure oxygen having greater than about 90 mole percent oxygen, or oxygen-enriched air having greater than about 21 mole percent oxygen. Substantially pure oxygen is preferred in the industry. To obtain substantially pure oxygen, air is compressed and then separated into substantially pure oxygen and substantially pure nitrogen in an air separation plant. Such plants are known in the industry.

The oxygen stream and the prepared carbonaceous or hydrocarbonaceous feedstock are introduced into the gasifier or gasifiers wherein the oxygen is consumed and the feedstock is substantially converted into a raw synthesis gas (referred to hereinafter as “syngas”) typically comprising carbon monoxide, hydrogen, carbon dioxide, water. The precise manner in which oxygen and feedstock are introduced into the gasifier is within the skill of the art. The raw syngas may comprise other impurities such as, for example, hydrogen sulfide, carbonyl sulfide, methane, ammonia, hydrogen cyanide, hydrogen chloride, mercury, arsenic, and other metals, depending on the feedstock source and gasifier type. In addition to a gasifier, the gasification process of the invention can comprise water-gas shift reactors, high temperature gas cooling equipment, ash/slag handling equipment, carbon dioxide, sulfur and acid gas removal sections, gas filters, and scrubbers.

In addition to a high pressure gasifier, the gasification process of the invention comprises a CO shift reaction section. The term “section” is used herein to refer to one or more process units, such as reactors, condensers, heat exchangers, etc. As the synthesis gas exits the gasifier, it is passed to a CO shift reaction section where it is reacted with water or steam in the presence of a catalyst to increase the fraction of hydrogen. In particular, the synthesis gas is reacted with water (typically as steam) and a suitable catalyst to convert carbon monoxide to carbon dioxide and hydrogen by way of the water-gas shift reaction. The CO shift reaction also is referred to as “steam reforming” and is described, for example, in U.S. Pat. No. 5,472,986. In addition to increasing the fraction of hydrogen, the CO shift reaction reduces the carbon monoxide in the gas mixture which, as noted above, can be a poison to the ammonia synthesis catalyst.

Typically the CO shift reaction is accomplished over a catalyst by methods known in the art. The CO shift reaction catalyst can be one or more Group VIII metals on a heat resistant support. Conventional randomly packed ceramic supported catalyst pieces as used, for example, in secondary reformers, can be used, but since these apply a significant pressure drop to the gas, it is often advantageous to use a monolithic catalyst having through-passages generally parallel to the direction of reactants flow.

The shift reaction is reversible, and lower temperatures favor hydrogen and carbon dioxide. However, the reaction rate is slow at low temperatures. Therefore, it is often advantageous to have high-temperature and low-temperature shift reactions in sequence. The gas temperature in a high-temperature shift reaction typically is in the range 350° C. to 1050° C. High-temperature catalysts are often iron oxide combined with lesser amounts of chromium oxide. Low-temperature shift reactors have gas temperatures in the range of about 150° C. to 300° C., more typically between about 200° C. to 250° C. Low-temperature shift catalysts are typically copper oxides that may be supported on zinc oxide and alumina. Some shift reaction catalysts can operate in the presence of sulfur, while others cannot (for example, copper-based catalyst). It is preferred that the design and operation of the shift reaction section result in a minimum of pressure drop so that the pressure of the synthesis gas can be preserved.

Alternatively the water-gas shift reaction may be accomplished without the aid of a catalyst when the temperature of the gas is greater than about 900° C. Because of the highly exothermic nature of the water-gas shift reaction, steam may be generated by recovering heat from the exit gases of the water gas-shift reactor. The CO shift reaction may be accomplished in any reactor format known in the art for controlling the heat release of exothermic reactions. Examples of suitable reactor formats are single stage adiabatic fixed bed reactors; multiple-stage adiabatic fixed bed reactors with interstage cooling, steam generation, or cold-shotting; tubular fixed bed reactors with steam generation or cooling; or fluidized beds.

As the synthesis gas is discharged from the CO shift reaction section, it is usually subject to a cooling and cleaning operation involving a scrubbing technique wherein the gas is introduced into a scrubber and contacted with a water spray which cools the gas and removes particulates and ionic constituents from the synthesis gas. The effluent from the shift reactor or reactors may contain 4 to 50 mole percent carbon dioxide, which may need to be reduced.

The carbon dioxide can be reduced by any of a number of methods known in the art for removal of carbon dioxide from gaseous streams at any of the pressures contemplated for the process of the invention. For example, the carbon dioxide may be removed by chemical absorption methods, exemplified by using aqueous caustic soda, potassium carbonate or other inorganic bases, or alkanol amines. These methods may be carried out contacting the synthesis gas with a liquid absorption medium in any suitable liquid-gas contactor known to the art such as, for example, a column containing trays or packing. Examples of suitable alkanolamines for the present invention include primary and secondary amino alcohols containing a total of up to 10 carbon atoms and having a normal boiling point of less than about 250° C. Specific examples include primary amino alcohols such as monoethanolamine (MEA), 2-amino-2-methyl-1-propanol (AMP), 1-aminobutan-2-ol, 2-amino-butan-1-ol, 3-amino-3-methyl-2-pentanol, 2,3-dimethyl-3-amino-1-butanol, 2-amino-2-ethyl-1-butanol, 2-amino-2-methyl-3-pentanol, 2-amino-2-methyl-1-butanol, 2-amino-2-methyl-1-pentanol, 3-amino-3-methyl-1-butanol, 3-amino-3-methyl-2-butanol, 2-amino-2,3-dimethyl-1-butanol, and secondary amino alcohols such as diethanolamine (DEA), 2-(ethylamino)-ethanol (EAE), 2-(methylamino)-ethanol (MAE), 2-(propylamino)-ethanol, 2-(isopropylamino)-ethanol, 2-(butylamino)-ethanol, 1-(ethylamino)-ethanol, 1-(methylamino)-ethanol, 1-(propylamino)-ethanol, 1-(isopropylamino)-ethanol, and 1-(butylamino)-ethanol. Many of these amino alcohols are available commercially.

Alternatively, carbon dioxide in the synthesis gas may be removed by physical absorption methods. Examples of suitable physical absorbent solvents are methanol (“Rectisol”) and other alkanols, propylene carbonate and other alkyl carbonates, dimethyl ethers of polyethylene glycol of two to twelve glycol units and mixtures therein, commonly known under the trade name of Selexol™ solvents, n-methyl-pyrrolidone (“Purisol”); and sulfolane (“Sulfinor”). Physical and chemical absorption methods may be used in concert as exemplified by the Sulfinol™ process using sulfolane and an alkanolamine as the absorbent, or the Amisol™ process using a mixture of monoethanolamine and methanol as the absorbent. Other examples of established carbon dioxide removal processes include “Amine Guard”, “Benfield”, “Benfield-DEA”, “Vetrocoke” and “Catacarb.

Sulfur, usually in the form of sulfur-containing compounds such as, for example hydrogen sulfide, and other acid gases present in the syngas in addition to carbon dioxide also may be removed by methods well known in the art. For example, sulfurous compounds may be recovered from the syngas in a sulfur removal zone by chemical absorption methods, exemplified by using caustic soda, potassium carbonate or other inorganic bases, or alkanol amines. Examples of suitable alkanolamines for the present invention include primary and secondary amino alcohols containing a total of up to 10 carbon atoms and having a normal boiling point of less than about 250° C. Specific examples include primary amino alcohols such as monoethanolamine (MEA), 2-amino-2-methyl-1-propanol (AMP), 1-aminobutan-2-ol, 2-amino-butan-1-ol, 3-amino-3-methyl-2-pentanol, 2,3-dimethyl-3-amino-1-butanol, 2-amino-2-ethyl-1-butanol, 2-amino-2-methyl-3-pentanol, 2-amino-2-methyl-1-butanol, 2-amino-2-methyl-1-pentanol, 3-amino-3-methyl-1-butanol, 3-amino-3-methyl-2-butanol, 2-amino-2,3-dimethyl-1-butanol, and secondary amino alcohols such as diethanolamine (DEA), 2-(ethylamino)-ethanol (EAE), 2-(methylamino)-ethanol (MAE), 2-(propylamino)-ethanol, 2-(isopropylamino)-ethanol, 2-(butylamino)-ethanol, 1-(ethylamino)-ethanol, 1-(methylamino)-ethanol, 1-(propylamino)-ethanol, 1-(isopropylamino)-ethanol, and 1-(butylamino)-ethanol.

Alternatively, sulfurous compounds may be removed by physical absorption methods. Examples of suitable physical absorbent solvents are methanol and other alkanols, propylene carbonate, and other alkyl carbonates, dimethyl ethers of polyethylene glycol of two to twelve glycol units and mixtures therein, commonly known under the trade name of Selexol™ solvents, n-methyl-pyrrolidone, and sulfolane. Physical and chemical absorption methods may be used in concert as exemplified by the Sulfinol™ process using sulfolane and an alkanolamine as the absorbent, or the Amisol™ process using a mixture of monoethanolamine and methanol as the absorbent. Typically, the synthesis gas is contacted with the solvent in an gas-liquid contactor which may be of any type known to the art, including packed columns or a column having trays. Operation of such an acid removal contactor is known in the art. The synthesis gas can be also be concentrated using known methods in the art such as membrane separation and/or a pressure swing absorption.

The sulfurous compounds in the syngas also may be removed by solid sorption methods using fixed, fluidized, or moving beds of solids exemplified by zinc titanate, zinc ferrite, tin oxide, zinc oxide, iron oxide, copper oxide, cerium oxide, or mixtures thereof. The sulfur removal equipment may be preceded by one or more gas cooling steps to reduce the temperature of the syngas as required by the particular sulfur removal technology utilized therein. Sensible heat energy from the syngas may be recovered through steam generation in the cooling train by means known in the art. Typically at least 90%, more typically at least 98% of the sulfur in the feed gas can be removed by the sulfur removal methods described hereinabove.

The high pressure synthesis gas stream comprising hydrogen is passed from the gasification process as a feed to a process for making ammonia. Typically, the high pressure H₂ gas stream from the gasification process has a pressure of about 49 to 63 bar. For example, the pressure of the gas stream can be about 56 bar. Thus, the pressure of hydrogen supplied from the gasification process of the invention typically exceeds that provided by natural gas-based method, which is generally about 25 to 32 bar. It is estimated that increasing the hydrogen product pressure to about 49 to about 63 bar can reduce the horsepower demand for a typical ammonia synthesis loop compressor by 30% to 40%. The hydrogen resulting from the above gasification process typically has a purity of between 96 and about 99.99 mole percent, more typically between about 99 and 99.9 mole percent.

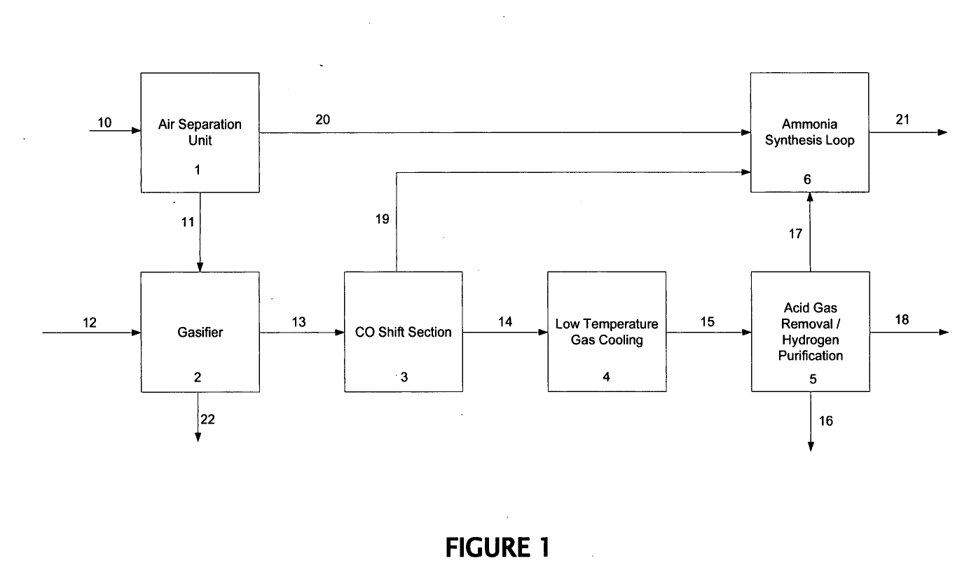

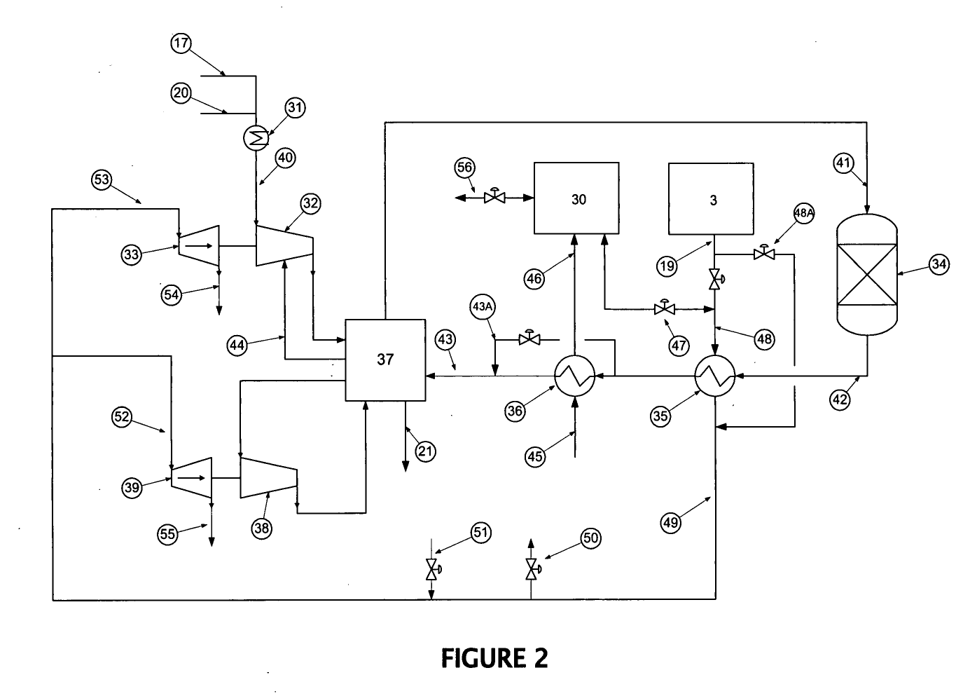

The shift reaction section of the gasification process described above can generate high pressure steam at various pressures and degrees of superheat. The term “high pressure”, as used herein, is understood to mean a pressure of about 22bar or greater. Examples of saturated steam pressures which can be generated by the shift reaction section are about 22 bar to about 63 bar, about 22 bar to about 60 bar, about 22 bar to about 55 bar, about 22 bar to about 50 bar, and about 22 bar to about 45 bar. For example, 42 bar saturated steam can be generated from the CO shift section. This 42 bar saturated steam provides flexibility and efficient integration into the ammonia steam system. For example, the steam is to be directly connected into the ammonia synthesis loop steam system. This is shown in FIG. 1 and FIG. 2.

Typically, the ammonia-making process comprises an ammonia converter section which produces an ammonia product stream. The high pressure syngas is introduced to the ammonia process generally by way of the ammonia synthesis loop compressor. This gas is admixed with nitrogen and with recycled ammonia synthesis feedstock gas, thereby creating a larger volume of hydrogen and nitrogen feedstock gas. The resulting ammonia synthesis feedstock gas typically contains the hydrogen and nitrogen reactants in the molar ratio of between about 2.7:1 to about 3.2:1, more typically between about 2.8:1 to about 3.1:1, and most typically between about 2.9:1 to about 3.0:1. Inerts are present in the range of between about 1 and about 30 mole percent, more typically in the range of about 5 to about 20 mole percent.

The ammonia feedstook gas mixture is compressed and used in the synthesis of ammonia. Typically, in conventional ammonia plants, pressures of between about 15 bar and about 346 bar are used. More typically, the pressures are between about 42 bar and about 346 bar, and most typically, between about 56 bar and about 167 bar. The ammonia synthesis feedstock gas is passed over an ammonia synthesis catalyst which catalyzes the hydrogenation of nitrogen to ammonia. The catalyst can be contained in one or more tubular or bed reactors, and these reactors may be set-up in a series of one or more reactors. In such cases, there may be provisions for cooling the gas between ammonia synthesis reactors. The ammonia synthesis catalyst may be any type known in the industry for the synthesis of ammonia such as, for example, as described in U.S. Pat. No. 5,846,507.

The ammonia is recovered from the product gas, and a portion of the remaining ammonia synthesis feedstock gas is recycled. Recovery of the ammonia is generally by condensation, though any method known to the art, including water or solvent scrubbing, is practicable. Condensation may be assisted by expanding the gas, or by cooling with refrigeration, cooling water or liquid nitrogen from an oxygen plant. The resulting ammonia depleted product gas is then compressed and most of the ammonia depleted product gas is recycled as ammonia synthesis feedstock gas. The passage of hydrogen and nitrogen through the ammonia reactor, recovery of ammonia product, and recycle of the unreacted nitrogen and ammonia is referred to herein as the ammonia synthesis loop. The order of compression, admixing the hydrogen-rich syngas and the nitrogen, and ammonia recovery is not important.

The hydrogenation of nitrogen is exothermic and heat must be removed from the effluent ammonia product stream in order to recover the ammonia. Thus, in one embodiment of the invention, all or a portion of the ammonia product stream can be heat exchanged with all or a portion of the high pressure saturated steam from the shift reaction section of the gasification to produce superheated steam. The term “superheated”, as used herein, is understood to mean that the steam is heated above its dew point at a given pressure. The amount of superheat typically is at least 40° C. Other examples of superheat are at least 45° C., at least 50° C., at least 60° C., and at least 70° C. For example, a portion of the saturated steam from the CO shift section may be passed to the ammonia process steam header. Alternatively, all of the high pressure, saturated steam from the CO shift section may be converted to superheated steam. According to the invention, at least 35% of the total superheated steam load for the ammonia synthesis process can generated by heat exhange with the ammonia product stream. The total superheated steam load is understood to mean the total superheated steam per unit of time used in the ammonia synthesis process such as, for example, the superheated steam used to drive turbines, pumps, heating, or other process needs. Other examples of superheat which can be provided by heat-exchange with the ammonia product stream include at least 40% of the total superheat load, at least 50%, at least 60%, and 100%. The exchange of heat between the product ammonia stream and the high-pressure saturated steam from the shift reaction can be accomplished using any appropriate superheater, that is, a heat exchanger part of a boiler for increasing the temperature of saturated steam to superheated steam. The heat-exchanger may be any type well known to persons skilled in the art such as, for example, a parallel, counterflow, or cross flow exchanger. These exchangers may be constructed, for example, in a shell and tube exchanger format.

The superheated steam can be passed to one or more steam turbine drivers which, in turn, can be used to drive one or more compressors used in the ammonia process. For example, the superheated steam can be passed to a steam turbine driver for a hydrogen and nitrogen feedstock compressor, an ammonia refrigeration compressor, or both. To match the steam pressure generated by the CO shift reaction, it is desirable that at least one of the steam turbine drivers is a condensing turbine rated for about 22 to about 63 bar steam. Other examples of condensing turbine ratings for the method of the invention include, but are not limited to, about 22 bar to about 60 bar, about 22 bar to about 55 bar, about 22bar to about 50 bar, and about 22 bar to about 45 bar. The term “condensing steam turbine”, as used herein, means a simple steam turbine in which high-pressure steam is expanded through the condensing steam turbine to generate power or electricity, and the exhausted steam typically is withdrawn from one or more stages at low pressure (less than 2 bar) and condensed for heating, plant process, or feedwater heater needs. For example, in one embodiment of the invention, the steam turbine driver for the hydrogen and nitrogen feedstock compressor is a condensing turbine rated for about 22 to about 63 bar steam. A single turbine may be used for the hydrogen and nitrogen feedstock compressor or more than one turbine may be used. In another example, the steam turbine drivers for both the hydrogen and nitrogen feedstock compressor and the ammonia refrigeration compressor are 42 bar condensing turbines. In a further example, the superheated steam may be used to drive additional steam turbines apart from the turbines used to drive hydrogen and nitrogen feedstock compressor and ammonia refrigeration compressor such as, for example, condensing steam turbines and pumps.

In another embodiment of the invention, additional high pressure, superheated steam can be generated using heat from the raw syngas stream produced by the gasifier prior to the shift reaction or purification sections. Methods to recover heat from the hot, raw syngas exiting the gasifier reaction chamber are known in the art and include, but are not limited to, quench, full heat recovery, and a combination thereof. For example, in the syngas quench method, the raw syngas from the gasifier is shock-cooled with water. In another example, known as full heat recovery, the raw syngas is cooled using a syngas cooler. In yet another example, a combination of both the quench and radiant syngas cooler can be used. In the quench method, the raw syngas leaves the gasifier through a quench tube of which the bottom end is submerged in a pool of water. In passing through this water, the raw gas is cooled to the saturation temperature of the water and is cleaned of slag and soot particles. The cooled, saturated syngas then exits the gasifier/quench vessel through a duct on the sidewall.

In the full heat recovery version, the raw syngas leaves the gasifier reaction section and is cooled in a radiant syngas cooler. The recovered heat is used to superheat and generate high pressure steam. Radiant syngas coolers are known in the art and may comprise, for example, at least one ring of vertical water cooled tubes, such as shown and described in U.S. Pat. Nos. 4,310,333 and 4,377,132.

The compressors used in the ammonia process of the invention can be of any type commonly used and well known in the art. For example, the hydrogen and nitrogen feedstock compressor can comprise a single casing, meaning that the compression mechanism is enclosed in one housing. In another example, the compressors of the ammonia process can be reciprocating compressor, a centrifugal compressor, a rotary compressor, or a combination thereof. The selection of the particular compressor type is dependent on the number of factors such as, for example, compression ratio and gas volume and within the knowledge of the person of ordinary skill in the art.

After passing through the superheater, the ammonia product stream also may be used to generate high-pressure, saturated steam by passage through a heat exchanger with boiler feed water. This high-pressure, saturated steam may directed to the process steam header or may be combined with the high-pressure saturated steam from the CO shift reaction section before heat exchange with the ammonia product stream. Alternatively, if additional high pressure, saturated steam is desired, a portion of the ammonia product stream can be routed around the superheater and used to generate additional high-pressure, saturated steam from boiler feed water.

The method of the invention may be used for new, “greenfield” ammonia/gasification plants or may be applied to existing ammonia plants that are retrofitted with a gasification process as a source of high pressure hydrogen. For example, the ammonia synthesis loop of a typical natural gas-based ammonia plant may modified by replacing the existing steam expansion turbine drivers and compressors designed to take advantage of the steam integration between the gasification and ammonia processes. Thus, in one embodiment, the invention further comprises replacing existing steam turbine drivers and compressors for compressing hydrogen and nitrogen feedstock in an ammonia-making process with one steam turbine driver and one compressor comprising a single casing.

In natural gas-based ammonia plants, typically there are two major steam headers used, a 104 bar and 42 bar steam headers. The 104 bar superheated steam header is often used to power the ammonia synthesis loop topping turbine. The steam exhaust from this turbine may go into a 42 bar steam header. The 42 bar steam header can be used to power such process equipment such as, for example, condensing steam turbines and pumps.

The existing steam turbine drivers of a typical natural gas-based ammonia plant may comprise, for example, a 104 bar to 42 bar topping and 42 bar condensing turbine. The term “topping turbine”, as used herein, is synonymous with the terms “superposed turbine” and “backpressure turbine”, and is intended to have its commonly understood meaning in the art, that is, a high-pressure, non-condensing turbine that can be added to a new plant or retrofitted to an older, moderate-pressure plant. Topping turbines receive high-pressure steam and produce an exhaust steam that is at the same pressure as the old boilers and is used to supply the old turbines. These existing turbines will be replaced with a properly sized condensing turbine rated for about 22 to about 63 bar steam. Other examples of condensing turbine ratings for the method of the invention include, but are not limited to, about 22 bar to about 60 bar, about 22 bar to about 55 bar, about 22 bar to about 50 bar, and about 22 bar to about 45 bar. The exhaust from this condensing turbine may be passed to a surface condenser.

The existing steam generation in the ammonia synthesis loop can be modified to generate about 22 to about 63 bar superheated steam. As described above, the saturated steam which is generated in both ammonia synthesis process and gasification process can be combined and superheated in the ammonia synthesis process. As described above, at least 35% of the total superheated steam load for the ammonia process can generated by heat exhange with the ammonia product stream. Other examples of superheat which can be provided by heat-exchange with the ammonia product stream include at least 40% of the total superheat load, at least 50%, at least 60%, and 100%. For example, the 104 bar steam generators can be replaced with about 22 to about 63 bar steam generators and a steam super-heater. Other examples of steam generators include, but are not limited to, about 22 bar to about 60 bar, about 22 bar to about 55 bar, about 22 bar to about 50 bar, and about 22 bar to about 45 bar. The about 22 to about 63 bar saturated steam generated in the ammonia synthesis loop and the gasification process can be superheated in this super-heater. The superheated steam can be used as the steam supply for the ammonia synthesis loop and/or refrigeration compressor or others. This embodiment of the invention is illustrated in FIG. 2.

In addition to the ammonia synthesis loop compressor and refrigeration compressor, the superheated steam generated in the above manner can be used to power other process equipment in the ammonia synthesis loop. Other uses for the superheated steam include turbine expansion drivers for boiler feed water pumps, turbine expansion drivers for other pumps and compressors, or to generate electricity. The balance of the superheated steam for other users will depend on the specific steam requirements of a particular facility.

In addition to replacing the turbines, the existing hydrogen and nitrogen feedstock compressors of the ammonia plant typically comprise two separate vessel cases, the low pressure case and the high pressure case. The low pressure case takes fresh feed as suction and discharges directly into the suction of the high pressure case. According to the invention, by raising the pressure of the hydrogen feedstock to about 49 to about 63 bar and modifications to the high pressure case compressor, the low pressure casing compressor can be eliminated. This embodiment also is illustrated in FIG. 2. Eliminating the low stage compressor and driver can reduce the total horsepower demand, capital, operating, and maintenance costs of the ammonia synthesis compression step.

As noted above, minor modifications to the high stage compressor may be required to take suction at about 49 to about 63 bar and discharge to required synthesis loop operating pressure. For example, the suction temperature to the high stage may be lowered in this process design to about 40° F. to about 60° F., typically about 40° F. In typical ammonia plants, the suction temperature to the low stage is about 40° F. and to the high stage as high as about 120° F. Because the low stage is not required with the present invention, the colder synthesis gas can go directly to the high stage and can reduce the horsepower demand of the compressor.

In addition to the method described hereinabove, the present invention also provides integrated process for making hydrogen and ammonia, comprising:
(a) reacting a carbonaceous material with oxygen in a high-pressure gasifier to produce a high-pressure gasifier product stream comprising hydrogen, carbon dioxide, carbon monoxide, and water;
(b) passing the gasifier product stream to a CO shift reaction section to produce a high-pressure shift reaction section product stream comprising additional hydrogen and carbon dioxide;
(c) generating high-pressure, saturated steam using heat from the shift reaction section product stream;
(d) passing the shift reaction section product stream to a purification section to remove CO₂ and H₂S, and form a high-pressure, purified gasification product stream comprising hydrogen;
(e) passing the high-pressure, purified gasification product stream and nitrogen to a hydrogen and nitrogen feedstock compressor to produce an ammonia converter feedstream;
(f) passing the ammonia converter feedstream to an ammonia converter section to form an ammonia product stream;
(g) heat exchanging the ammonia product stream with the high-pressure, saturated steam from the shift reaction section to form superheated steam wherein at least 50% of the total superheated steam load for the ammonia process is produced by the heat-exchange; and
(h) passing the superheated steam to a steam turbine driver for the hydrogen and nitrogen feedstock compressor, a steam turbine driver for an ammonia refrigeration compressor, or to both.
   The various embodiments of the gasification process, shift reaction, ammonia process, steam turbine driver, compressors, steam and heat integration are as described previously. For example, the high-pressure gasifier may have an operating pressure range of about 42 to about 84 bar or, in another example, about 67 to about 77 bar. The gas from the gasifier is passed to a CO shift reaction section and to a purification section, as described previously, where all or a portion of the CO₂ and sulfur-containing compounds such as, for example, H₂S, are removed or their concentrations reduced to produce a high-pressure purified gasification product stream comprising hydrogen. The process can have a heat exchanger for generating high-pressure, saturated steam from the CO shift reaction. The purified H₂-containing, gasification product stream, which can have a pressure of about 49 to about 63 bar, and nitrogen can be combined with recycled, unreacted feedstock, and passed to a hydrogen and nitrogen feedstock compressor to produce fresh ammonia converter feedstock. The compressed hydrogen and nitrogen feedstock can be then passed to an ammonia converter section where the hydrogen and nitrogen are reacted to product a product stream comprising ammonia. The high-pressure, saturated steam from the shift reaction section can be passed to a superheater and used to produce a high-pressure superheated steam by heat exchange with the ammonia product stream. At least 35% of the total superheated steam load for the ammonia process can generated by heat exhange with the ammonia product stream. Other examples of superheat which can be provided by heat-exchange with the ammonia product stream include at least 40% of the total superheat load, at least 50%, at least 60%, and 100%. As described previously, this superheated steam may be passed to a steam turbine driver for a hydrogen and nitrogen feedstock compressor, a ammonia refrigeration compressor, or both. The steam turbine drivers, typically, will be rated for about 22 to about 63 bar steam, but other ratings are possible such as, for example, about 22 bar to about 60 bar, about 22 bar to about 55 bar, about 22 bar to about 50 bar, and about 22 bar to about 45 bar. As described above, various compressor types and formats as understood in the art may be used. The superheated steam may be used to drive additional steam turbines.

After passing through the superheater, the ammonia product stream also may be used to generate high-pressure, saturated steam by passage through a heat exchanger with boiler feed water. This high-pressure, saturated steam may directed to the process steam header or may be combined with the high-pressure saturated steam from the CO shift reaction section before heat exchange with the ammonia product stream. Alternatively, if additional high pressure, saturated steam is desired, a portion of the ammonia product stream can be routed around the superheater and used to generate additional high-pressure, saturated steam from boiler feed water.

The invention also provides an integrated system for making hydrogen and ammonia, the system comprising:
(a) a high-pressure gasifier for reacting a carbonaceous material with oxygen to produce a high pressure gasifier product stream comprising hydrogen, carbon dioxide, carbon monoxide, and water;
(b) a CO shift reaction section for converting the carbon monoxide and water in the gasifier product stream to produce a high-pressure shift reaction section product stream comprising additional hydrogen and carbon dioxide;
(c) a first heat exchanger section for generating high-pressure, saturated steam using heat from the shift reaction section product stream;
(d) a purification section for removing CO₂ and H₂S, and forming a high-pressure, purified gasification product stream comprising hydrogen;
(e) a nitrogen and hydrogen feedstock compressor for compressing the high-pressure, purified gasification product stream and nitrogen to produce an ammonia converter feedstream;
(f) an ammonia converter section for reacting hydrogen with nitrogen in the ammonia converter feedstream to produce a product stream comprising ammonia;
(g) a second heat exchanger section for exchanging heat from the ammonia product stream to the high-pressure, saturated steam from the shift reaction section to form superheated steam; and
(h) a steam turbine driver for the nitrogen and hydrogen feedstock compressor or a steam turbine driver for an ammonia refrigeration compressor, which receives at least a portion of the superheated steam.
   The various embodiments of the gasification process, shift reaction, ammonia process, steam turbine driver, compressors, steam and heat integration are as described previously. For example, the high-pressure gasifier may have an operating pressure range of about 42 to about 84 bar or, in another example, about 67 to about 77 bar. The gas from the gasifier is passed to a CO shift reaction section and to a purification section, as described previously, where all or a portion of the CO₂ and sulfur-containing compounds such as, for example, H₂S, are removed or their concentrations reduced to produce a high-pressure purified gasification product stream comprising hydrogen. The purified H₂-containing, gasification product stream, which can have a pressure of about 49 to about 63 bar, and nitrogen can be combined with recycled, unreacted feedstock, and passed to a hydrogen and nitrogen feedstock compressor to produce fresh ammonia converter feedstock. The compressed hydrogen and nitrogen feedstock can be then passed to an ammonia converter section where the hydrogen and nitrogen are reacted to product a product stream comprising ammonia. The process can have a first heat exchanger for generating high-pressure, saturated steam from the CO shift reaction. This high-pressure, saturated steam can be passed to a second heat exchanger or superheater and converted to high-pressure, superheated steam by heat exchange with the ammonia product stream. At least 35% of the total superheated steam load for the ammonia process can generated by heat exhange with the ammonia product stream. Other examples of superheat which can be provided by heat-exchange with the ammonia product stream include at least 40% of the total superheat load, at least 50%, at least 60%, and 100%. As described previously, this superheated steam may be passed to a steam turbine driver for a hydrogen and nitrogen feedstock compressor, a ammonia refrigeration compressor, or both. The steam turbine drivers, typically, will be rated for about 22 to about 63 bar steam, but other ratings are possible such as, for example, about 22 bar to about 60 bar, about 22 bar to about 55 bar, about 22 bar to about 50 bar, and about 22 bar to about 45 bar. As described above, various compressor types and formats as understood in the art may be used. The superheated steam may be used to drive additional steam turbines.

The process may further comprise additional heat exchangers for recovery of extra heat from the ammonia process stream. For example, as described previously, the ammonia product stream also may be used to generate high-pressure, saturated steam by passage through a third exchanger with boiler feed water after passing through the second heat exchanger (or superheater) described above. The process may also comprise a conduit for combining the high-pressure, saturated steam from the first heat exchanger section with the high-pressure, saturated steam from the third heat exchanger section to form a combined high-pressure, saturated steam stream that can be fed into the second heat exchanger to generate superheated steam. All or a portion of the high-pressure, saturated steam from the third exchanger also may be directed to the ammonia process steam header for general use throughout the ammonia process. Alternatively, if additional high pressure, saturated steam is desired, a portion of the ammonia product stream can be routed around the superheater and used to generate additional high-pressure, saturated steam from boiler feed water.

One embodiment of the present invention may be illustrated with particular reference to the block flow diagram showing integration of a gasifier into an existing ammonia plant, is depicted in FIG. 1. In FIG. 1, stream 10 containing air is fed into an air separation unit (ASU) 1. The ASU 1 separates air into a predominately oxygen stream 11 and a predominately nitrogen stream 20. The predominately oxygen stream 11 is used as part of the feed to a gasifier 2 where the oxygen is combined with a hydrocarbonaeous material 12 and steam or water (not shown). Partial oxidization occurs within the gasifier 2 resulting in a crude synthesis gas 13 and particulate matter 22. The crude synthesis gas stream 13 is passed to a CO shift section 3, where CO is converted to H₂ and CO₂ in the presence of steam. The chemical reaction in the CO shift section 3 is exothermic, and heat is recovered in the form of high pressure saturated steam 19. This high pressure saturated steam 19 is passed to the ammonia synthesis loop 6 for further steam integration. Syngas stream 14 exiting the CO shift section 3 is cooled by heat exchanger 4 and then passed to an acid gas removal section 5. In this section, the cooled crude synthesis gas stream 15 is purified to a predominately H₂ product stream 17, which is fed to the ammonia synthesis loop 6. Stream 18 containing CO₂ and stream 16 containing H₂S are withdrawn from acid gas removal section 5 and used in other processes. In the acid gas removal section 5, the H₂ product can be further purified by utilizing such common technologies as pressure swing adsorption, membranes, or methanization reaction. The H₂ product stream 17 and nitrogen stream 20 are mixed in stoichiometric amounts in the ammonia synthesis process 6, which is described in FIG. 2 below, to form an ammonia synthesis feedstock 21.

Another embodiment of the invention may be illustrated in FIG. 2 that depicts a process flow diagram of an ammonia synthesis plant. In FIG. 2, an H₂ product stream 17 from the acid gas removal and purification section 5 (from FIG. 1) is mixed in stoichmetric amounts with a predominately nitrogen stream 20 from the air separation unit 1 (from FIG. 1). These combined streams make up the ammonia synthesis fresh feedstock 40. The ammonia synthesis fresh feedstock 40 is chilled by heat exchanger 31. The fresh feedstock 40 and ammonia synthesis reactor recycle gas 44 are compressed by a single-barrel ammonia synthesis circulating loop compressor 32 and fed to an ammonia synthesis loop gas processing section 37.

Section 37 represents a number of process steps/equipment known in the art for preparing the ammonia synthesis feed gas stream 41 for ammonia conversion and for separating the ammonia converter section product stream 43 into ammonia product 21 and a recycle gas stream 44. Such process steps include heating the ammonia synthesis feed gas stream 41, as well as separating and condensing out ammonia product 21 from the ammonia converter section product stream 43.

The prepared ammonia synthesis gas 41 is fed to an ammonia synthesis converter 34 in which the exothermic ammonia-forming reaction causes a temperature rise. The ammonia synthesis reaction can be accomplished in one or more ammonia synthesis converters with integrated heat exchange. Hot effluent 42 from the last ammonia synthesis converter passes to a steam superheater 35 and boiler feed water (BFW) preheater/steam generator 36. The steam superheater 35 and BFW preheater/steam generator 36 cool the ammonia converter effluent 42 to form a cooled ammonia converter effluent stream 43. Further cooling of the effluent stream 43 takes place in the synthesis loop gas processing section 37. A by-pass line 43A around the BFW preheater/steam generator 36 is provided for greater temperature control of the cooled ammonia converter effluent stream 43.

In the synthesis loop gas processing section 37, ammonia product 21 is separated from the cooled ammonia converter effluent stream 43, and un-reacted synthesis gas 44 is recycled back to the ammonia synthesis compressor 32.

Boiler feed water 45 is supplied to the BFW preheater/steam generator 36, and heated BFW or high-pressure saturated steam 46 is generated, depending on the amount of heat available from the ammonia synthesis converter gas 42 after the superheater 35. The heated BFW or saturated steam 46 is then passed to the ammonia synthesis section steam header 30. Saturated steam can be imported into or exported from the ammonia synthesis section steam header 30 via line 56.

High-pressure saturated steam from the ammonia synthesis section steam header 30 can be mixed with the high-pressure saturated steam 19 from the CO shift reactor section 3 via line 47. The combined high-pressure saturated steam 48 is then passed to a steam superheater 35 to produce a high-pressure superheated steam 49. A portion of the high-pressure saturated steam from the CO shift reactor section 3 can bypass the steam superheater 35 via line 48A for plant start-up and/or temperature control.

Depending on the ammonia production unit 6 (FIG. 1) steam requirements, superheated steam in line 49 can be exported via line 50 to other uses or imported in line 51 from auxiliary boilers. The high-pressure superheated steam from line 49 can be supplied via line 53 to the steam extraction turbine 33 to drive the ammonia synthesis compressor 32 and/or via line 52 to the steam extraction turbine 39 to drive the ammonia refrigeration compressor 38. Exhaust gas from the steam extraction turbine drivers 33 and 39 can be sent to a condenser (not shown) and the condensate recovered via lines 54 and 55.

In a methane-based ammonia synthesis process, the majority of steam production is accomplished in the hydrogen production process. When replacing with the gasification process, there is not sufficient steam to power existing plant process steam expansion turbines, and the steam expansion turbines are replaced with electric motors. As seen from the above, the present invention allows for superior energy integration into an existing ammonia plant with the ability to use steam turbines instead of electric drivers to power major plant equipment.

The above embodiments are intended to serve as illustrations of the present invention. One of ordinary skill in the art of chemical engineering should understand and appreciate that specific details of any particular embodiment may be different and will depend upon the location and needs of the system under consideration. All such layouts, schematic alternatives, and embodiments capable of achieving the present invention are considered to be within the capabilities of a person having skill in the art and thus within the scope of the present invention.

I claim:

1. A method for integrating a process for making hydrogen with a process for making ammonia, said method comprising:
(a) reacting a carbonaceous material with oxygen in a gasification process, said gasification process comprising a high-pressure gasifier and a CO shift reaction section having a shift reaction section product stream;
(b) passing a high-pressure synthesis gas stream comprising hydrogen from said gasification process as a feed to a process for making ammonia, said ammonia-making process comprising an ammonia converter section having an ammonia product stream;
(c) generating high-pressure, saturated steam using heat from the shift reaction section product stream;
(d) heat exchanging all or a portion of said high-pressure, saturated steam from step (c) with all or a portion of said ammonia product stream to produce superheated steam wherein at least 50% of the total superheated steam load for said ammonia process is produced by said heat-exchange; and
(e) passing said superheated steam to a steam turbine driver for a hydrogen and nitrogen feedstock compressor, a steam turbine driver for an ammonia refrigeration compressor, or to both.

2. The method according to claim 1, wherein the high-pressure gasifier has an operating pressure range of 42 to 84 bar.

3. The method according to claim 2, wherein the high-pressure gasifier is operated at 67 to 77 bar.

4. The method according to claim 1, wherein the high-pressure gas stream comprising hydrogen has a pressure of 49 to 63 bar.

5. The method according to claim 1 wherein at least one of said steam turbine drivers is a condensing turbine rated for about 22 to about 63 bar steam.

6. The method according to claim 5 wherein said steam turbine driver for said hydrogen and nitrogen feedstock compressor is a condensing turbine rated for about 22 to about 63 bar steam.

7. The method according to claim 6 wherein said hydrogen and nitrogen feedstock compressor comprises a single casing.

8. The process according to claim 7 wherein said hydrogen and nitrogen feedstock compressor is a reciprocating compressor, a centrifugal compressor, or a rotary compressor.

9. The method according to claim 1 further comprising replacing existing steam turbine drivers and compressors for compressing hydrogen and nitrogen feedstock in said ammonia-making process with one steam turbine driver and one compressor comprising a single casing.

10. The method according to claim 9, wherein the existing steam turbine drivers comprise a 104 bar topping turbine and a 42 bar condensing turbine.

11. The method according to claim 9, wherein the existing compressors comprise two or more casings.

12. The method according to claim 1, further comprising using said superheated steam is used to drive additional steam turbines.

13. The method according to claim 1 further comprising generating additional high pressure, superheated steam using heat from a raw syngas gasifier stream.

14. The method according to claim 1, further comprising the steps of:
(f) generating high-pressure, saturated steam using heat from the ammonia product stream; and
(g) combining the high-pressure, saturated steam from step (c) with the high-pressure, saturated steam from step (f) prior to step (d).

15. An integrated process for making hydrogen and ammonia, said process comprising:
(a) reacting a carbonaceous material with oxygen in a high-pressure gasifier to produce a high-pressure gasifier product stream comprising hydrogen, carbon dioxide, carbon monoxide, and water;
(b) passing said gasifier product stream to a CO shift reaction-section to produce a high-pressure shift reaction section product stream comprising additional hydrogen and carbon dioxide;
(c) generating high-pressure, saturated steam using heat from the shift reaction section product stream;
(d) passing said shift reaction section product stream to a purification section to remove CO₂ and H₂S, and form a high-pressure, purified gasification product stream comprising hydrogen;
(e) passing said high-pressure, purified gasification product stream and nitrogen to a hydrogen and nitrogen feedstock compressor to produce an ammonia converter feedstream;
(f) passing said ammonia converter feedstream to an ammonia converter section to form an ammonia product stream;
(g) heat exchanging said ammonia product stream with said high-pressure, saturated steam from the shift reaction section to form superheated steam, wherein at least 50% of the total superheated steam load for said ammonia process is produced by said heat-exchange; and
(h) passing said superheated steam to a steam turbine driver for said hydrogen and nitrogen feedstock compressor, a steam turbine driver for an ammonia refrigeration compressor, or to both.

16. The process according to claim 15, wherein said high-pressure gasifier has an operating pressure range of 42 to 84 bar.

17. The process according to claim 15, wherein said high-pressure gasifier is operated at 67 to 77 bar.

18. The process according to claim 15, wherein said high-pressure, purified gasification H₂ product stream has a pressure of 49 to 63 bar.

19. The process according to claim 15, wherein said steam turbine drivers are rated for about 22 to about 63 bar steam.

20. The process according to claim 15, wherein said superheated steam is used to drive additional steam turbines.

21. The process according to claim 15 wherein said hydrogen and nitrogen feedstock compressor is a reciprocating compressor, a centrifugal compressor, or a rotary compressor.

22. The proecess according to claim 21 wherein said hydrogen and nitrogen feedstock compressor comprises a single casing.

23. The process according to claim 15, further comprising the steps of:
(i) generating high-pressure, saturated steam using heat from the ammonia product stream; and
(j) combining the high-pressure, saturated steam from step (c) with the high-pressure, saturated steam from step (i) prior to step (g).

24. An integrated system for making hydrogen and ammonia, said system comprising:
(a) a high-pressure gasifier for reacting a carbonaceous material with oxygen to produce a high pressure gasifier product stream comprising hydrogen, carbon dioxide, carbon monoxide, and water;
(b) a CO shift reaction section for converting the carbon monoxide and water in said gasifier product stream to produce a high-pressure shift reaction section product stream comprising additional hydrogen and carbon dioxide;
(c) a first heat exchanger section for generating high-pressure, saturated steam using heat from the shift reaction section product stream;
(d) a purification section for removing CO₂ and H₂S, and forming a high-pressure, purified gasification product stream comprising hydrogen;
(e) a nitrogen and hydrogen feedstock compressor for compressing said high-pressure, purified gasification product stream and nitrogen to produce an ammonia converter feedstream;
(f) an ammonia converter section for reacting hydrogen with nitrogen in said ammonia converter feedstream to produce a product stream comprising ammonia;
(g) a second heat exchanger section for exchanging heat from said ammonia product stream to said high-pressure, saturated steam from the shift reaction section to form superheated steam; and
(h) a steam turbine driver for said nitrogen and hydrogen feedstock compressor or a steam turbine driver for an ammonia refrigeration compressor, which receives at least a portion of said superheated steam.

25. The system according to claim 24, wherein the high-pressure gasifier has an operating pressure range of 42 to 84 bar.

26. The system according to claim 24, wherein the high-pressure gasifier has an operating pressure of 67 to 77 bar.

27. The system according to claim 24, wherein the steam turbine drivers are rated for about 22 to about 63 bar steam.

28. The system according to claim 24, which further comprises:
(i) a third heat exchanger section for exchanging heat from said ammonia product stream to boiler feed water to generate high-pressure, saturated steam; and
(j) a conduit for combining said high-pressure, saturated steam from said first heat exchanger section with said high-pressure, saturated steam from said third heat exchanger section to form a combined high-pressure, saturated steam stream that can be fed into said second heat exchanger to generate superheated steam.
